(19) United States
(12) Patent Application Publication
(10) Pub. No.: US 2006/0173983 A1
(43) Pub. Date: Aug. 3, 2006

(54) Information processing system and method of controlling information processing system

(75) Inventors: Takao Naito, Kawasaki (JP); Toshiki Tanaka, Kawasaki (JP); Kouichiro Amemiya, Kawasaki (JP)

Correspondence Address: BINGHAM MCCUTCHEN LLP, 3000 K STREET, NW, BOX IP, WASHINGTON, DC, 20007, US

(73) Assignee: FUJITSU LIMITED

(21) Appl. No.: 11/145,971

(22) Filed: Jun. 7, 2005

(30) Foreign Application Priority Data
Feb. 3, 2005 (JP) 2005-027936

(51) Int. Cl. G06F 15/173

(52) U.S. Cl. 709/223

(57) ABSTRACT

The present invention provides an information processing system which comprises multiple processor nodes creating parallel computers, an information transmission line for connecting the processor nodes, and a separation switch provided on the information transmission line for separating the information transmission line so that the processor nodes create multiple parallel computers independent of one another.

### BACKGROUND OF THE INVENTION

1. Field of the Invention

The present invention relates to an information processing system and a method of controlling the information processing system, and particularly to a technique that can be effectively applied to an information processing technique or the like such as the parallel processing based on load balancing by using a plurality of processor nodes and the like.

2. Description of the Related Art

High performance computers that are capable of simulating various physical phenomena in the natural field or in manufactured objects have been used for designs and simulations in the fields of nuclear utilization, automobiles, ships, aircrafts, high-rise buildings and the like. Also, recently, high performance computers have been used in the field of biotechnology and chemistry, for such purposes as molecular design, genetic analysis and the like, in order to be utilized not only in universities or research laboratories, but also in business enterprises. High performance computers are used for various processor applications and the processing time thereof varies very much.

As methods for realizing the above high performance computer, the techniques below are used to increase the speed of recursive computations whose computation amount is large (e.g., the matrix computation which is conducted frequently in the sci-tech fields).

Specifically, there is (1) a technique for enhancing the performance of each processor itself, (2) a technique for enhancing the degree of the parallelism of multiple parallel-connected processors and (3) a technique for realizing the parallel processing by using a special computation device called a vector processor.

Usually, a high performance computer is realized by selecting one or more of the above techniques (1) to (3). In the case of the parallel computer whose processors exhibit a high degree of parallelism, enhancement of the performance of the network connecting the various processors becomes more important.

In many cases, when an application requires a large scale computation to be executed, the computation is conducted with a priority on reducing the computation time by occupying the entire high performance computer.

Conversely, when an application requires just a small or middle scale computation to be executed, it is advantageous to execute simultaneously different programs to promote efficient utilization of the above high performance computer. In this case, a consideration for security is necessary so that there is no leakage of information among users between the execution of each application's computations.

Especially in the latter case, it is important to heighten security among the various users. A software counter measure is possible to implement, in which, for example, user specific information is included in the information transmitted among processor nodes so that processes may discriminate by user on what information is used. However, this presents a new problem in that the delay time of the information transmission is increased by the overhead of the transmitted information that the user discrimination process entails.

Accordingly, in a conventional high performance computer, there is a tendency to simplify the processes used to transmit information between processor nodes to increase the performance of the information transmission speed and the transmission capacity among processor nodes. Therefore, a software counter measure is difficult to employ because it causes deterioration of performance and more complexity in configuration.

In Japanese Patent Application Publication No. 2004-532447, a technique is disclosed in which, in a parallel computer a group consisting of redundant spare processors is provided in order to realize fault tolerance by controlling the computer with software to replace a group that has experienced hardware failure. However, in the above Japanese Patent Application Publication No. 2004-532447, the above technical problem regarding securing the parallel computer when the parallel computer is simultaneously used by a plurality of different users is not recognized.

### SUMMARY OF THE INVENTION

One objective of the present invention is to provide an information processing technique that realizes a simultaneous use of a parallel computer by a plurality of users with a high level of security and without deteriorating the computation performance.

Another object of the present invention is to provide an information processing technique that realizes a parallel execution of multiple application programs with a variety of computation scales while maintaining the security among application programs.

Another object of the present invention is to realize an enhancement in the rate of operation of a parallel computer comprised of multiple processor nodes.

Another object of the present invention is to provide an information processing technique that realizes an enhancement in the failure resistance of a parallel computer by the separation of processor nodes in a unit of each processor node.

The first aspect of the present invention provides an information processing system, comprised of a plurality of processor nodes for creating parallel computers, an information transmission line for connecting the processor nodes, and a separation switch provided on the information transmission line for separating the information transmission line so that the multiple processor nodes may create multiple parallel computers that are independent of one another.

A second aspect of the present invention provides the information processing system as detailed in the first aspect, wherein the separation switch physically separates the information transmission line.

A third aspect of the present invention provides the information processing system as detailed in the first aspect, wherein each of the processor nodes comprises an input port and an output port, the separation switch holds a switch matrix for connecting multiple connection ports to which the input port and the output port are connected and the arbitrary connection port via the information transmission line, the switch matrix connects the input ports and the output ports of the plurality of the processor nodes to constitute loops, and the switch matrix skips and excludes a pair of the input port and the output port of each of the processor nodes from the loops so that the disconnection from the parallel computer is conducted in a unit of each of the processor nodes.

A fourth aspect of the present invention provides an information processing system, comprising first switches for binding grouped processor nodes and controlling routes of information transmitted among the processor nodes, a second switch for controlling routes of information transmitted among the processor nodes among the groups that the processor nodes are connected in a unit of the group via the first switches, and a third switch provided between the first switches and the second switch for controlling the presence and the absence of the connection with the second switch regarding each of the groups.

A fifth aspect of the present invention provides a method of controlling an information processing system to connect multiple processor nodes via an optical transmission line and cause the processor nodes to operate as parallel computers, establishing a step of arranging an optical switch on the optical transmission line, and a step of causing the processor nodes to operate as parallel computers that are independent of one another by separating the optical transmission line by the optical switch as occasion demands.

A sixth aspect of the present invention provides a method of controlling an information processing system in which a fat tree is established by binding multiple grouped processor nodes by first switches for controlling routes of information transmitted among the processor nodes in the groups and by binding multiple first switches by a second switch for controlling routes of information transmitted among the processor nodes among the various groups, creating a step of arranging a third switch on an information transmission line between the first switches and the second switch, and a step of constructing a plurality of parallel computers which are independent of one another in a unit of the group as a minimal unit by controlling the presence and the absence of the connection with the second switch regarding each of the groups by the third switch.

### BRIEF DESCRIPTION OF THE DRAWINGS

FIG. 1 is a schematic view showing an example of a configuration of an information processing system as an embodiment of the present invention;

FIG. 2 is a schematic view showing an example of the operation of the system in FIG. 1;

FIG. 3 is a block diagram showing an example of a configuration of a processor node constituting the information processing system as an embodiment of the present invention;

FIG. 4 is a schematic view that shows a modified example of the information processing system as an embodiment of the present invention;

FIG. 5 is a schematic view that shows another modified example of the information processing system as an embodiment of the present invention;

FIG. 6 is a block diagram that shows a modified example of the processor node constituting the information processing system as an embodiment of the present invention;

FIG. 7 is a schematic view that shows another modified example of the information processing system as an embodiment of the present invention;

FIG. 8 is a schematic view that shows another modified example of the information processing system as an embodiment of the present invention;

FIG. 9 is a schematic view that shows another modified example of the information processing system as an embodiment of the present invention;

FIG. 10 is a schematic view that shows an example of an operation of another modified example of the information processing system as an embodiment of the present invention;

FIG. 11 is a schematic view that shows a modified example of the information processing system as an embodiment of the present invention;

FIG. 12 is a block diagram that shows a configuration example of the information processing system for embodying the configuration of FIG. 11; and

FIG. 13 is a block diagram that shows an example of the operation of the information processing system of FIG. 12.

### DESCRIPTION OF THE PREFERRED EMBODIMENTS

Hereinafter, embodiments of the present invention will be explained in detail with reference to the drawings.

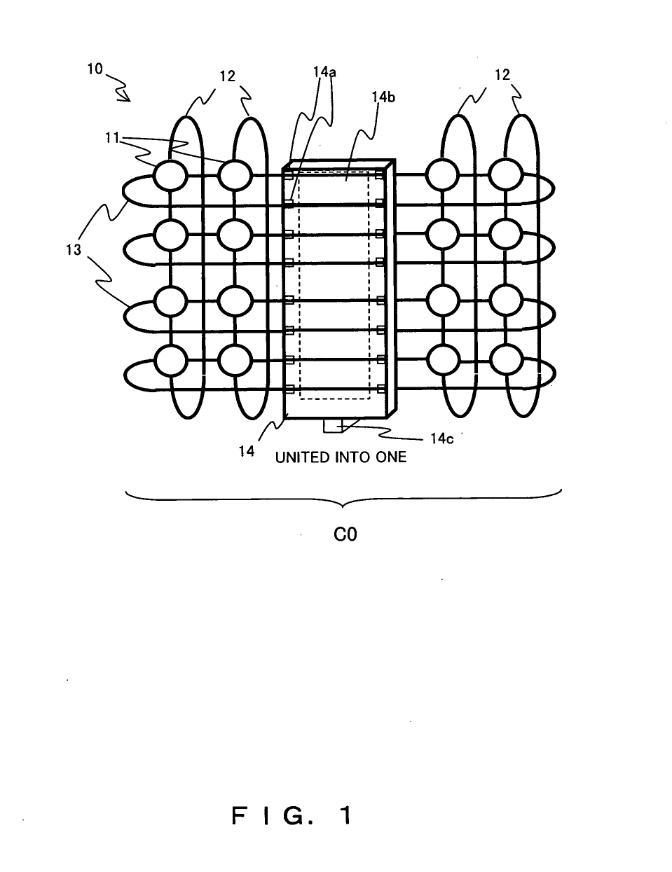

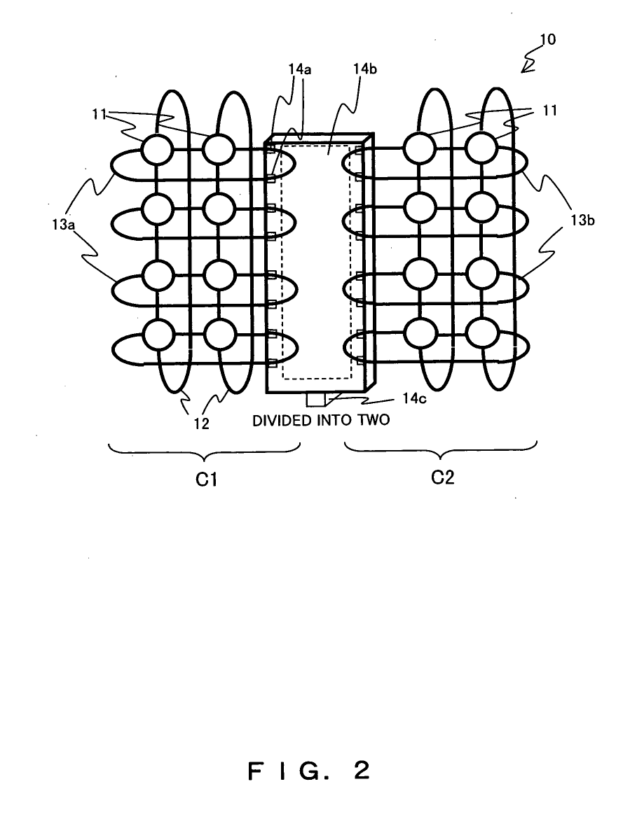

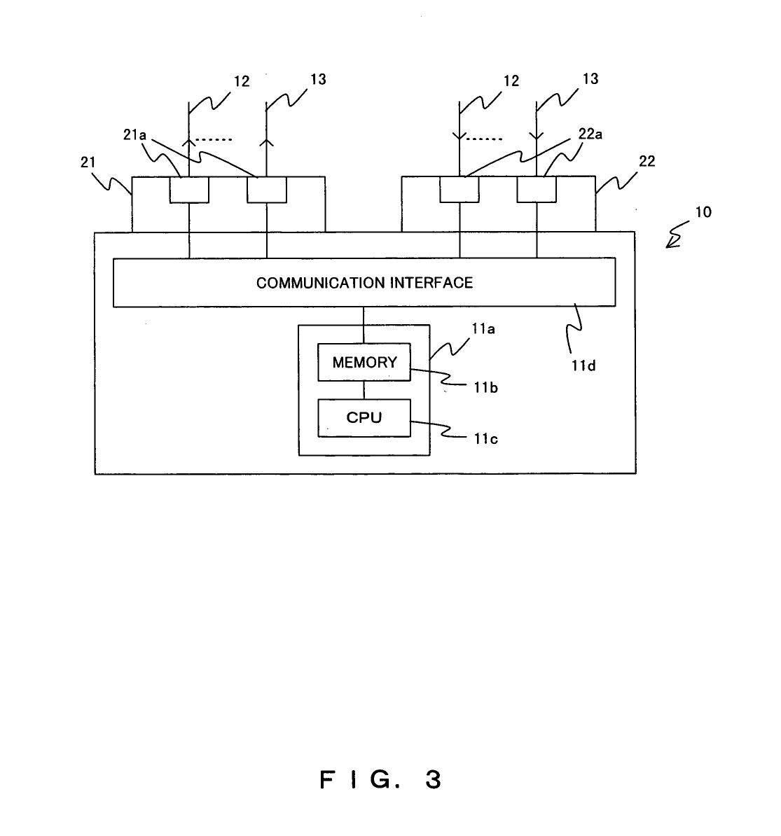

FIG. 1 is a schematic view that shows an example of a configuration of an information processing system which implements a method of controlling the information processing system as an embodiment of the present invention. FIG. 2 is a schematic view that shows an example of the operation of the above information processing system. FIG. 3 is a block diagram that shows an example of a configuration of each of the processor nodes constituting the information processing system as the present embodiment.

FIG. 1 shows a fundamental concept of partitioning multiple processor nodes in the torus connection. In the present embodiment, an example will be explained in which the system can be divided into multiple physically separated networks, i.e., into a plurality of parallel computers among which security is heightened by providing an optical switch on optical transmission lines connecting the processor nodes. However, it should be noted that for simplicity of the explanation, the example of the two dimensional torus connection of the plurality of the processor nodes is explained in FIG. 1 to FIG. 7 below.

As shown in FIG. 1, in an information processing system 10 according to the present embodiment, a plurality of processor nodes 11 are serially connected on each of rows and columns by vertical loop optical fibers 12 and horizontal loop optical fibers 13 so that a parallel computer C0 in the two dimensional torus connection is created.

Each processor node 11 comprises a computation core 11a, a communication interface 11d for connecting the computation core 11a to an optical signal-outputting unit 21 and an optical signal-inputting unit 22. The computation core 11a comprises, for example, a CPU 11c for executing computation processes, and memory, 11b in which information such as a program or data and the like for controlling the CPU 11c is stored.

In the optical signal-outputting unit 21 connected to the communication interface 11d, there is a plurality of fixed wavelength optical transmitters 21a, and each of the fixed wavelength optical transmitters 21a is connected to the vertical loop optical fibers 12 and the horizontal loop optical fibers 13.

In the optical signal-inputting unit 22 connected to the communication interface 11d, there is a plurality of fixed wavelength optical receivers 22a, and the vertical loop optical fibers 12 and the horizontal loop optical fibers 13 are connected to each of the fixed wavelength optical receivers 22a.

A message to be transmitted from one processor node 11 to other processor nodes is converted into an optical signal by the optical signal outputting unit 21, output to the vertical loop optical fibers 12 and the horizontal loop optical fibers 13, received by the optical signal-inputting unit 22, and transmitted to the computation core 11a after being converted into an electrical signal as occasion demands.

When the information processing system 10 in the two dimensional torus connection is realized as shown in FIG. 1, two inputs and two outputs are enough in the optical signal-inputting unit 22 and the optical signal-outputting unit 21 of each of the processor nodes 11 respectively.

In the present embodiment, an optical switch 14 (a separation switch) is provided on the route of the horizontal loop optical fiber. The optical switch 14 is comprised of multiple connection ports 14a, a switch matrix 14b for setting a connection route among the connection ports 14a and a separation control-inputting unit 14c for externally controlling the setting operation of the connection route by the switch matrix 14b.

In the configuration of FIG. 1, for simplicity, an example is shown in which the optical switch 14 is arranged in a position for separating the multiple processor nodes 11 into two equal groups. However, the separation is not necessarily for two equal groups. Also, the number of the optical switches 14 is not necessarily one but can be two or more for dividing the processor nodes 11 into three or more groups.

The switch matrix 14b is comprised of, for example, a plurality of micro movable mirrors each in a size of a cross section of an optical fiber created by employing a micro processing technique such as a micro electro mechanical system (MEMS) or the like, a driving circuit system for driving the movable mirrors by the static electricity or the like, and further, an optical system or the like for converging the optical signals which are incident and reflected on/by the movable mirrors. Accordingly, the transmission delay in the connected state and the separated state of the horizontal loop optical fiber 13 in the optical switch 14 is generally very small.

Each of the horizontal loop optical fibers 13 is divided by the optical switch 14 and each of the ends by the division is connected to its corresponding connection port 14a.

In the default state of the separation control-inputting unit 14c, the connection among the connection ports 14a is set so that each horizontal loop optical fiber 13 constitutes one loop. In this state, one parallel computer C0 is created by all of the processor nodes 11 (eleven in this case).

Also, when a separation instruction of the horizontal loop optical fibers 13 is made by the separation control-inputting unit 14c, in the switch matrix 14b, the connection routes via the separation control-inputting unit 14c are set so that a couple of connection ends of each of the horizontal loop optical fibers 13 create a loop as shown in FIG. 2, thereby separating the horizontal loop optical fibers 13 into two groups of separated loop optical fibers 13a and separated loop optical fibers 13b.

In this way are the multiple processor nodes 11 that were connected via the horizontal loop optical fibers 13 in the row direction separated into a group of separated loop optical fibers 13a (eight nodes in this case) and a group of separated loop optical fibers 13b (eight nodes in this case) to create a parallel computer C1 and a parallel computer C2 respectively, each being independent of the other.

In this case, in the separated state as shown in FIG. 2, the horizontal loop optical fibers 13 are completely separated physically into two groups of separated loop optical fibers 13a and separated optical fibers 13b so that the parallel computer C1 on the side of the separated loop optical fibers 13a and the parallel computer C2 on the side of the separated loop optical fibers 13b can operate physically independent of each other.

Therefore, the leakage of information can be certainly avoided between a simulation program executed by a user who uses the parallel computer C1 and another simulation program executed by another user who uses the parallel computer C2.

Further, complex software processes such as inserting special information in messages transmitted and received among the processor nodes 11 or reading the inserted special information from the message to sort it or the like for the sake of avoiding the leakage of information in the case that the parallel computer C0 is to be operated as parallel computers C1 and C2 is not necessary at all. Accordingly, the overhead due to the above software processes does not occur.

Therefore, one parallel computer C0 can operate as the independent parallel computers C1 and C2 without the occurrence of the overhead, while at the same time maintaining the high level security.

Also, when the parallel computer C0 created by causing the optical switch 14 to be in a connecting state and connecting all of the processor nodes 11 in the row direction by one horizontal loop optical fiber 13 is used, the overhead of the transmissions of the optical signals in the optical switch 14 does not occur so that the high performance of the parallel computer C0 is not deteriorated.

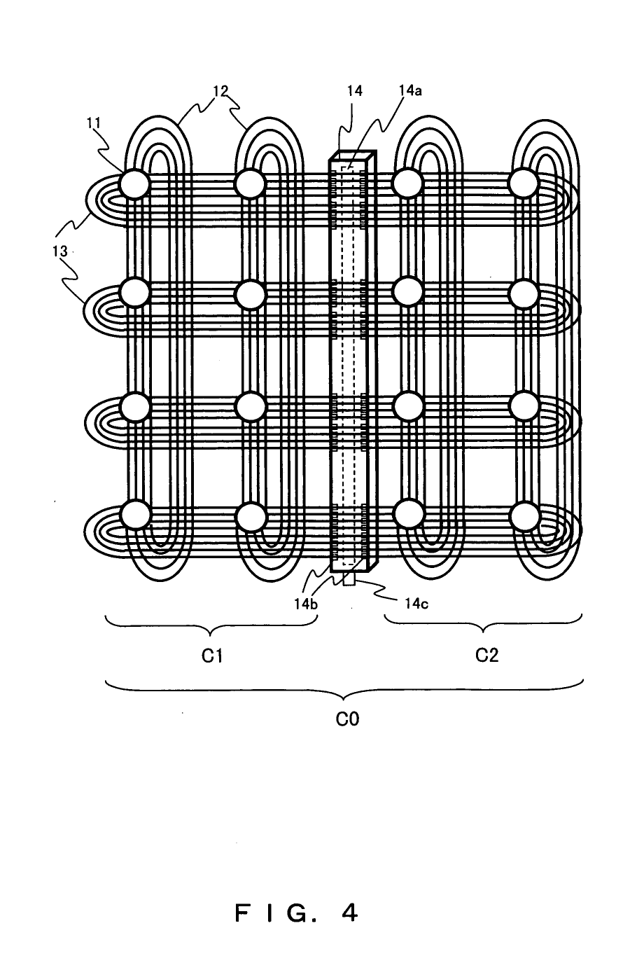

FIG. 4 is a schematic view that shows a modified example of the information processing system 10 according to the present embodiment. In the example of FIG. 4, a number each of the vertical loop optical fibers 12 and the horizontal loop optical fibers 13 is increased and the space division multiplexing (space-DM) is employed for the transmissions of the optical signals among the processor nodes 11 so that the communication capacity among the processor nodes is increased and the computation performance is enhanced.

Also in this case, an optical switch 14-1 uses the horizontal loop optical fibers 13 as connection means so that the parallel computer C0 is realized by the parallel connection of all of the processor nodes 11 (sixteen nodes in this case) A parallel computation of maximum performance is therefore realized.

Also, the parallel computer C1 and the parallel computer C2 which are physically independent from each other can be realized by setting the optical switch 14-1 in the separating state and separating the horizontal loop optical fibers 13 into a plurality of the separated loop optical fibers 13 and the separated loop optical fibers 13b. In the case of this separating state, the separated ends (connection ends with respect to the optical switch 14) of each optical fiber of the multiplexed horizontal loop optical fibers 13 are loop-connected in the switch matrix 14b similarly as the case in FIG. 2, whose configuration is not shown. With this configuration, it is desirable that the connections of the fibers among the space division multiplexed processor nodes can be simultaneously set in the separated state.

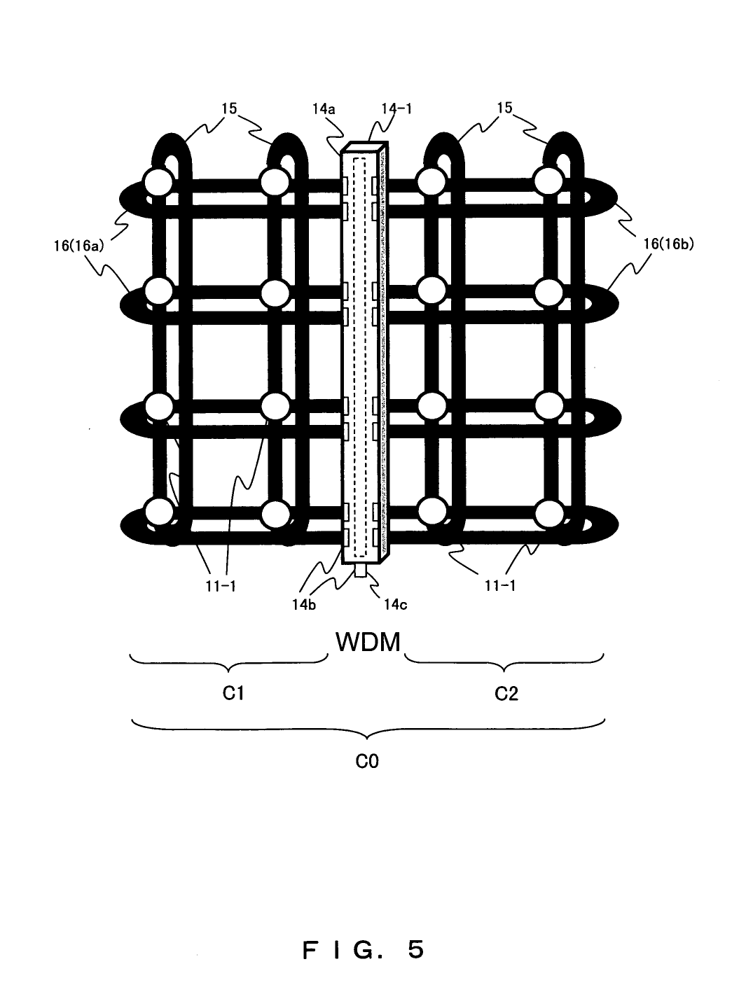

In the above multiplexing of the vertical loop optical fibers 12 and the horizontal loop optical fibers 13, a larger number of the optical fibers are required. Therefore, an example in which the number of the optical fibers constituting the vertical loop optical fibers 12 and the horizontal loop optical fibers 13 is reduced by using the optical signals of the wavelength division multiplexing (WDM) in FIG. 5 below.

FIG. 5 shows an example of the information processing system 10 in which the processor nodes 11-1 arranged for the two dimensional torus connection are connected in the column direction by one vertical wavelength multiplex optical fiber 15. The above processor nodes are also connected in the row direction by one horizontal wavelength multiplex optical fiber 16 similarly as in the column direction.

Further, in the connecting state of the optical switch 14-1, the parallel computer C0 is created by the parallel operations of all of the processor nodes 11-1. Also, as occasion demands, the parallel computer C1 and the parallel computer C2 which are independent from each other can be realized when the optical switch 14-1 separates the horizontal wavelength multiplex optical fibers 16 into two groups of separated wavelength multiplex fibers 16a and separated wavelength multiplex fibers 16b.

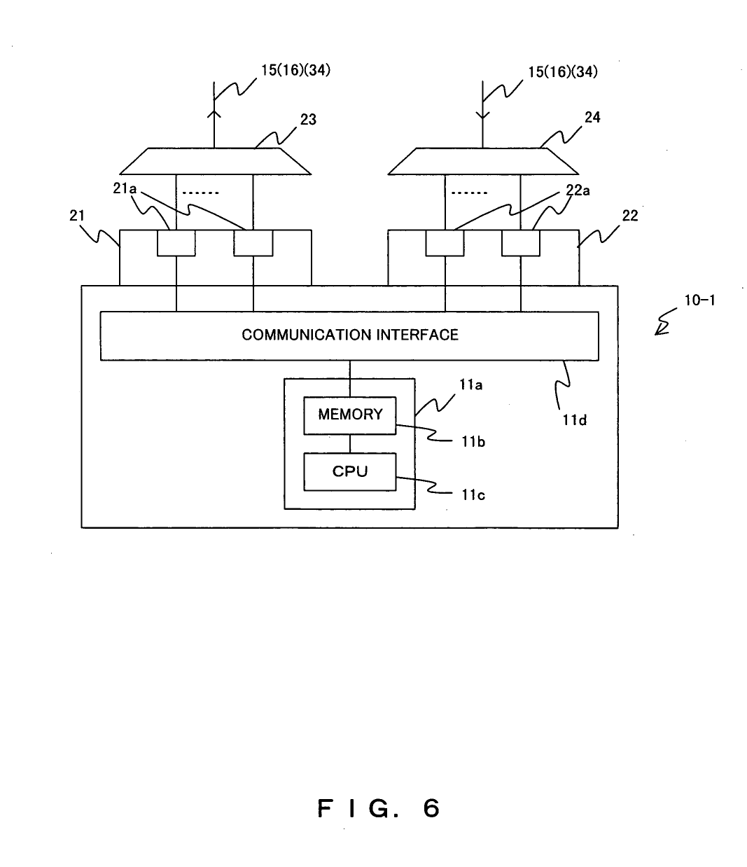

FIG. 6 shows a configuration example of the processor node 11-1 in the case of FIG. 5. Different points from the configuration of the processor node 11 shown in the above FIG. 3 will be explained hereinafter. In this case, on the side of the optical signal-outputting unit 21, a coupler 23 is provided for wavelength division multiplexing the various optical signals of the multi wavelength output from the fixed wavelength optical transmitter 21a and for outputting to the vertical wavelength multiplex optical fiber 15 and the horizontal wavelength multiplex optical fiber 16.

Also, on the side of the optical signal-inputting unit 22, a branching filter 24 is provided for branching the wavelength division multiplexed optical signals coming from the vertical wavelength multiplex optical fiber 15 and the horizontal wavelength multiplex optical fiber 16 for each wavelength and for inputting to the fixed wavelength optical receivers 22a.

There is merit in the fact that, by wavelength division multiplexing the vertical wavelength multiplex optical fibers 15 and the horizontal wavelength multiplex optical fibers 16 as shown in FIG. 5, the number of the connection ports 14a of the optical switch 14-1 can be decreased compared with that in the configuration of FIG. 4 so that the configuration of the optical switch 14-1 can be simplified.

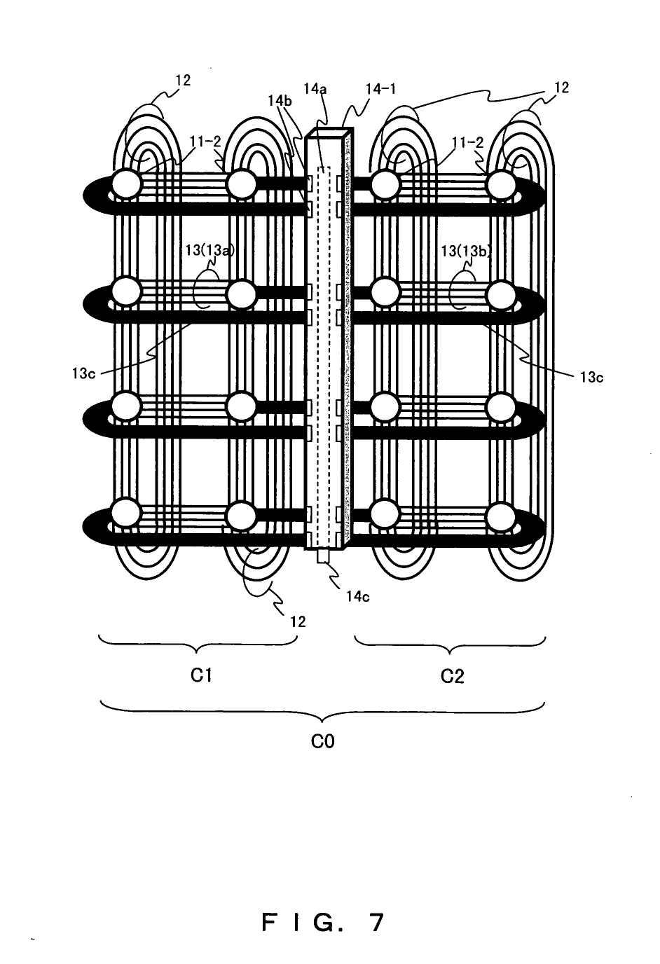

FIG. 7 is a schematic view that shows another modified example of the information processing system 10 according to the present invention. The configuration in FIG. 7 is the intermediate example between the configurations of FIG. 4 and FIG. 5. Specifically, among a plurality of routes of the horizontal loop optical fibers 13, the route portions being connected to the optical switch 14-1 are selectively utilized as one horizontal wavelength multiplex optical fiber 13c for transmitting wavelength division multiplexed optical signals.

In the above case, the optical signal-outputting unit 21 and the optical signal-inputting unit 22 of the processor nodes 11-2 connected to the horizontal loop optical fiber 13 (horizontal wavelength multiplex optical fiber 13c) are also of the intermediate configuration between the configurations of FIG. 3 and FIG. 6. Specifically, in the processor nodes 11 located at the ends of the route portions connected to the optical switch 14-1 in the horizontal loop optical fibers 13, one of the optical signal-outputting unit 21 and the optical signal-inputting unit 22 is of the configuration of FIG. 3 and the other is of the configuration of FIG. 6.

Generally, because an optical module comprising the coupler 23 and the branching filter 24 and the like used for the wavelength division multiplexing is expensive, the example in which the wavelength multiplexing is conducted only on the routes between the processor nodes between which the optical switch 14-1 is provided is explained in FIG. 7. In this case, there is merit in the fact that an optical switch 14-1 with a relatively smaller number of connection ports 14a can be used.

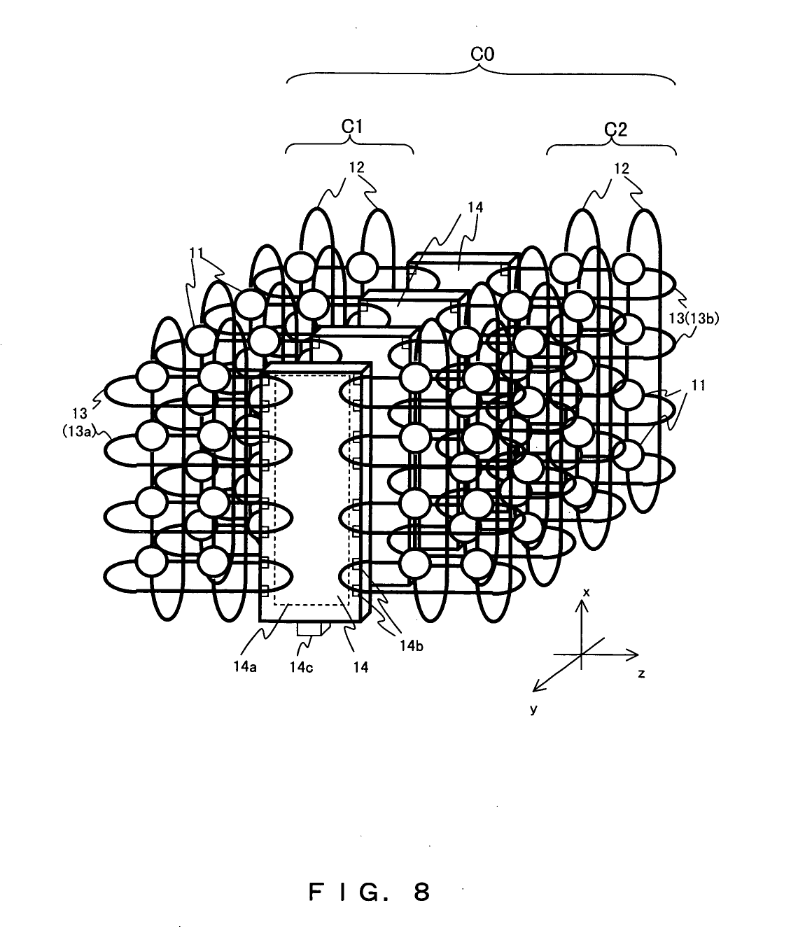

FIG. 8 shows an embodiment of partitioning in the parallel computer C0 in three dimensional torus connection configured by arranging the above configuration of FIG. 1 in the y-axis direction. It is to be noted that the connecting routes in the y-direction are not shown for simplicity of the figure, however, the connection in the y-direction is realized by the loop optical fibers similarly as those in the x-direction and the z-direction and the connection in the y-direction can be divided by the optical switch.

In addition, in FIG. 8, a state that the parallel computer C0 is divided into the parallel computers C1 and C2 by the multiple optical switches 14. When the optical switches 14 are set in the connecting state, the parallel computer C0 with all of the processor nodes 11 operating in parallel is created.

Similarly as in the case of the two dimensional torus connection of FIG. 1, the parallel computer C0 that causes all of the processor nodes 11 to operate in parallel, and the parallel computers C1 and C2 which are independent of each other by separating the parallel computer C0 on the horizontal loop optical fibers 13 (in the z-axis direction) by the multiple optical switches 14 can be realized.

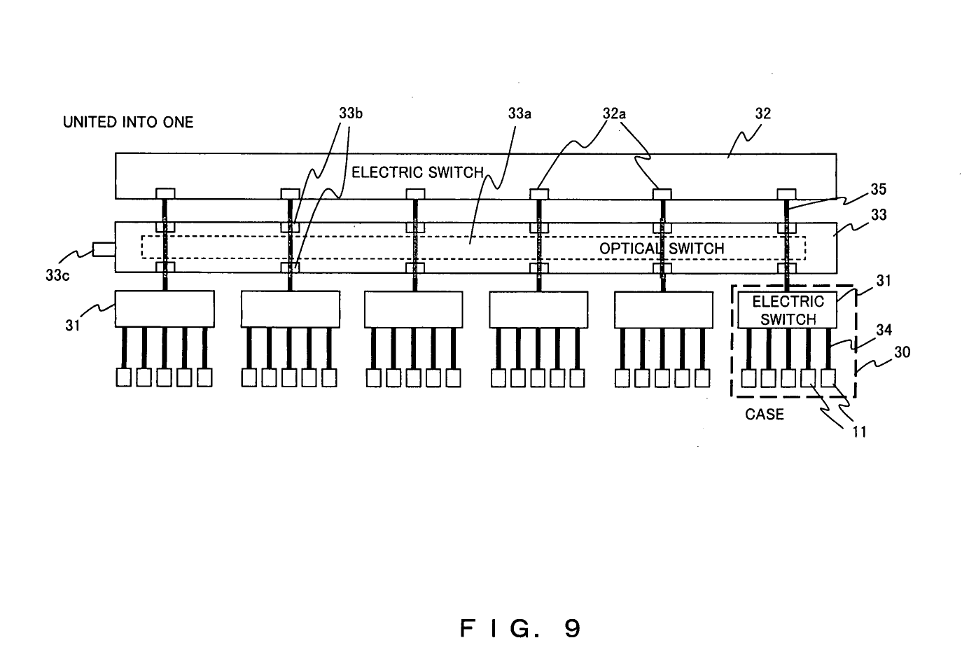

FIG. 9 is a schematic view that shows an example of partitioning in a tree connection of the plurality of processor nodes. FIG. 9 shows a configuration example in which multiple processor nodes 11 are connected by a fat tree configuration. In this configuration, the communication capacity between an electric switch 31 and an electric switch 32 is the communication capacity, including all of the communication capacities between respective processor nodes 11 and the electric switches 31 Therefore, a large amount of the communication capacity is required. Accordingly, it is desirable to employ wavelength multiplexing.

Specifically, multiple processor nodes 11 are each connected to the electric switches 31 (first switch) via optical fibers 34 for a group including the nodes in a prescribed number, and accommodated in cases 30 in a unit of the group.

The electric switch 31 connects the processor nodes 11 in the case 30 by a full mesh connection by a packet routing technique, for example.

The electric switch 31 of each of the cases 30 is further connected to the higher electric switch 32 (second switch) via the optical fiber 35. The optical fiber 35 transmits, for example, the wavelength division multiplexed optical signals between the electric switch 31 and the electric switch 32.

The electric switch 32 connects the cases 30 (electric switches 31) in the full mesh connection by, for example, a packet routing technique among multiple ports 32a to which the optical fibers 35 are connected from the side of the electric switches 31.

In the above case, on the routes of the optical fibers 35, an optical switch 33 (third switch) is provided. This optical switch 33 is comprised of multiple connection ports 33b to which the optical fibers 35 are connected from both of the electric switches 31 and the electric switch 32, a switch matrix 33a for disconnecting and setting of the connection routes regarding the optical transmission lines between these connection ports 33b and a separation control-inputting unit 33c for externally controlling the operation of the switch matrix 33a.

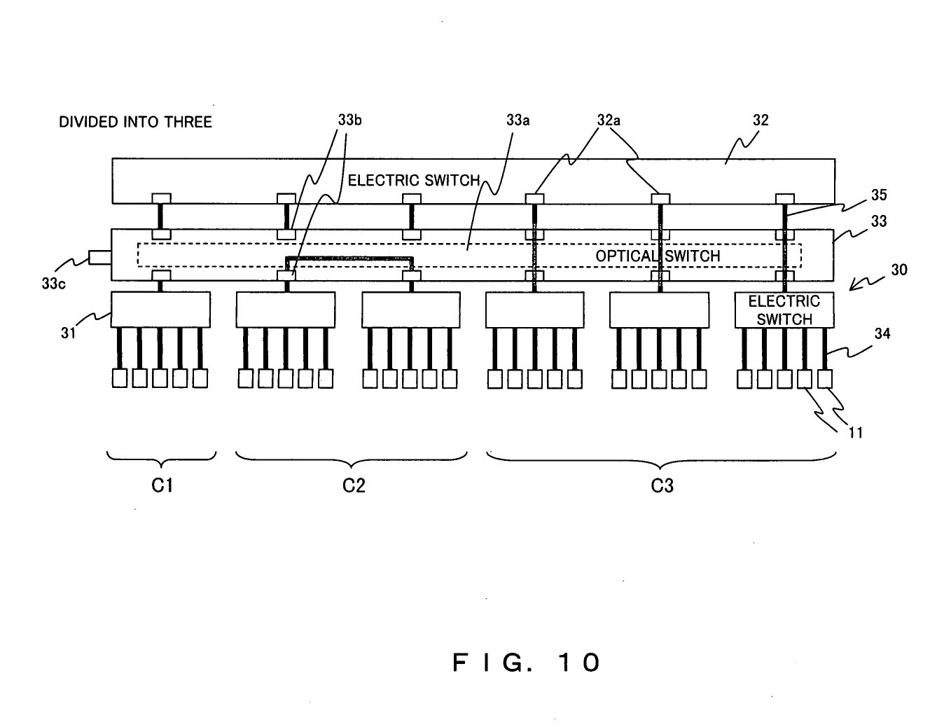

Further, in the present embodiment, as shown in FIG. 9, it is possible that by operating the separation control-inputting unit 33c, all of the cases 30 are connected to the electric switch 32 via the optical switch 33 so that the high performance parallel computer C0 is created that will cause all of the processor nodes 11 in all of the cases to operate in parallel. Further, the parallel computer C0 is used by being physically divided into multiple-parallel computers as shown in FIG. 10 as occasion demands.

Specifically, in the example of FIG. 10, the independent parallel computer C1 is created by separating the group of the processor nodes 11 in one case 30 located in the most left position from the electric switch 32, the parallel computer C2 comprised of two cases 30 is created by separating the second and the third cases from the left from the electric switch 32 and connecting the second and the third cases to each other in the switch matrix 33a, and the parallel computer C3 is created by connecting the three cases 30 on the right side to the electric switch 32 via the optical switch 33.

Accordingly, by setting one parallel computer C0 of the information processing system 10 to the separated state or the connected state among the cases 30 as shown in FIG. 10 based on the various settings of the switch matrix 33a of the optical switch 33, the parallel computer C0 can be divided into the parallel computers C1, C2 and C3 which are physically independent of one another, and operate independently.

In the configuration examples of FIG. 9 and FIG. 10, the optical switch 33 is provided between the electric switches 31 and the electric switch 32 respectively for binding multiple processor nodes 11 in a unit of the case 30 and binding all of the cases 30 so that the parallel computer C0 can be divided into more than one physically separated network; i.e., the parallel computers C1, C2 and C3 among which the security is secured, and can be operated independently. It should be noted that the electric switch 31 and the electric switch 32 are shown as examples in the above FIG. 9 and FIG. 10 so that optical packet switches can replace them.

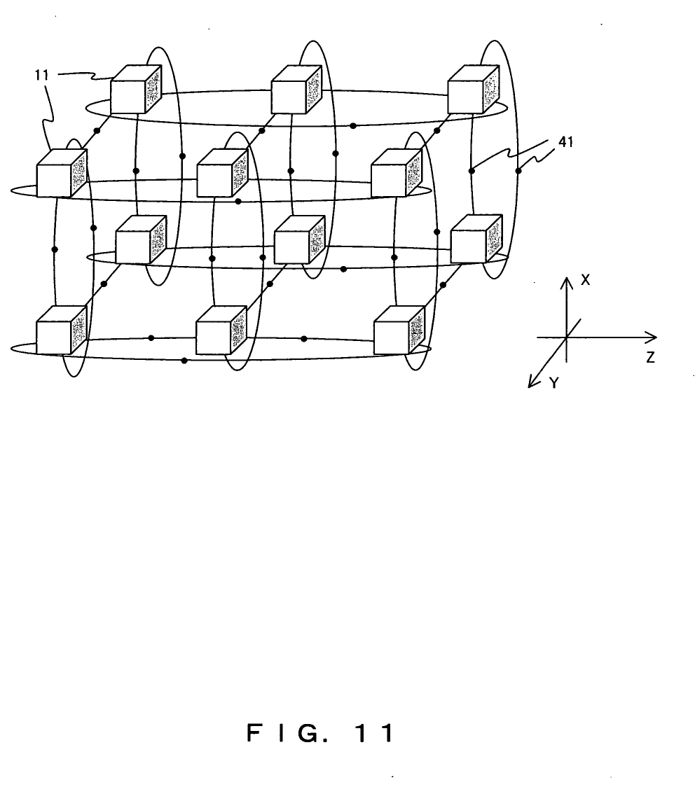

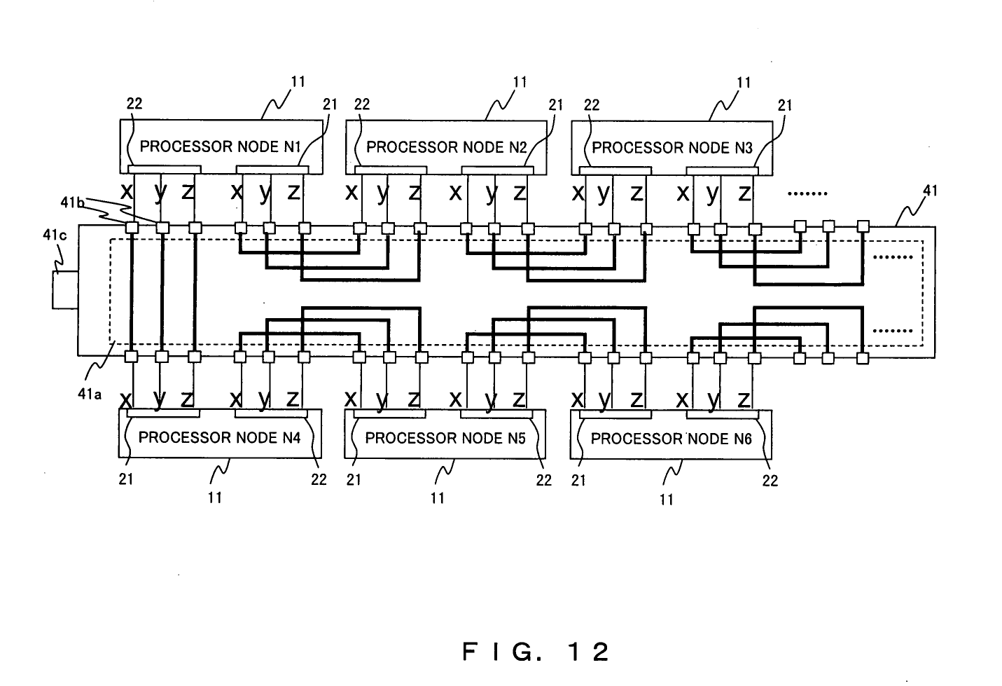

FIG. 11 is a schematic view for showing another modified example of the information processing system 10 according to the present embodiment. FIG. 12 is a block diagram for showing a configuration example of the information processing system to be used for embodying the configuration of FIG. 11.

In the configuration example of FIG. 11, multiple processor nodes 11 are connected based on the three-dimensional torus connection via optical fibers 42. a Also, optical switches 41 are provided on the connection route of each of the processor nodes 11 for separating one arbitrary processor node 11 from all the other processor nodes 11.

The connection configuration of the logical three dimensional torus connection of FIG. 11 can be realized by the two dimensional connection using the optical switches 41 as shown in FIG. 12.

Specifically, in each of the processor nodes 11, three fixed wavelength optical transmitters 21a and three fixed wavelength optical receivers 22a are provided in each of the optical signal-outputting units 21 and the optical signal inputting units 22 for receiving and transmitting the optical signals in the directions of the three dimensions of x, y and z. And each of the fixed wavelength optical transmitters 21a and three fixed wavelength optical receivers 22a are connected to the connection ports 41b of the optical switches 41 via the optical fibers 42.

Each of the optical switches 41 comprises a switch matrix 41a for connecting the input and output of each of the multiple connection ports 42b to other arbitrary connection ports 41b respectively corresponding to the axes of x, y and z. The above connection setting among the connection ports 41b by the switch matrix 41a can be externally controlled by a separation control-inputting unit 41c.

For example, in the example of FIG. 12, the input and output of the respective axes of x, y and z of the optical signal-outputting units 21 and the optical signal-inputting units 22 of all of the processor nodes 11 (processor nodes N1 to N6) are connected in loop based on the setting of the switch matrix 41a in the optical switch 41 so that the logical three dimensional torus connection as shown in FIG. 11 is realized.

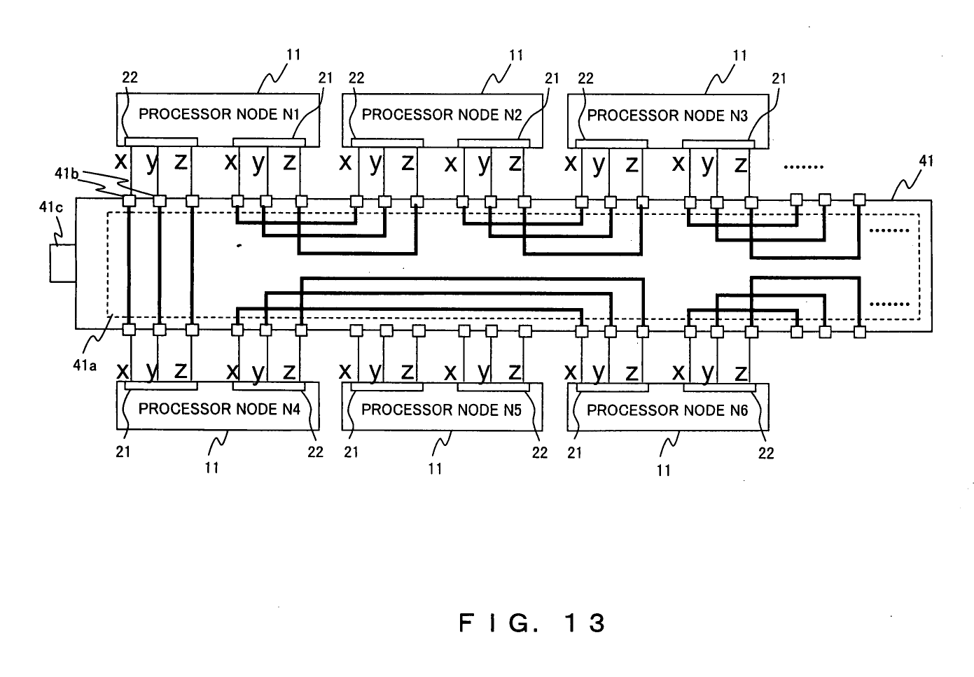

Further, when, for example, a failure has occurred in one processor node (processor node N5) or the processor node N5 has become dispensable, only the processor node N5 has to be disconnected from the three dimensional torus connection. In the above case, as shown in FIG. 13, the setting of the connection route in the switch matrix 41a is conducted so that the optical signal-outputting unit 21 and the optical signal-inputting unit 22 are directly connected to the processor node N4 and the processor node N6, respectively, without the connection with the connection ports 41b to which the optical signal-outputting unit 21 and the optical signal-inputting unit 22 of the processor node N5 are connected.

Thereby, only the processor node N5 with the failure or the dispensability can be disconnected from the three dimensional torus connection.

Additionally, when all of the transmission lines are connected in the three dimensional torus connection, some of the transmission lines are looped and the traffic becomes excessive so that the transmission amount overflows the transmission capacity and the link may go down. However, in the present embodiment, the optical switch 41 can suitably disconnect the link in accordance with the connection configuration of the processor nodes 11 which is required for each application so that the link going down due to the loop configuration of the transmission lines can be avoided.

Also, in FIG. 13, an example in which one processor node (processor node N5) is disconnected is shown. However, a plurality of processor nodes 11 can be divided into an independent group.

For example, in FIG. 12, neighboring processor nodes N2 and N3, and the neighboring processor nodes N5 and N6 are disconnected, and the optical signal-outputting unit 21 and the optical signal-inputting unit 22, are connected to the opposing processor node N2 and the processor node N5, respectively, so that an independent parallel computer comprised of the processor nodes N1, N2, N5 and N4 in the three dimensional torus connection can be realized.

As described above, according to the respective embodiments of the present invention, it is possible that the high performance computer comprised of multiple processor nodes 11 can be physically separated by the optical switch as occasion demands, that the parallel computers C1 to C3 that can be independently operated in parallel can be created, and the parallel computers C1 to C3 are used by different users for different applications (application programs). Also, the leakage of information among the application programs executed by respective users can be certainly avoided.

Accordingly, large-scale application programs that require high performance can be executed and parallel operations by multiple users can be realized with a high level of security so that the rate of operation can be enhanced by the use of the parallel computers in various tasks.

In addition, the present invention is not limited to the configurations explained in the above embodiments and it is obvious that various modifications are possible without departing from the spirit of the present invention.

For example, in the above respective embodiments, examples in which an optical fiber is used for the information transmission line have been offered. However, a metal cable can be used instead of an optical fiber, for example.

Utilizing the present invention, multiple users can use parallel computers simultaneously with a high level of security without deteriorating the computation performance.

Also, multiple application programs with a variety of computation scales can be executed in parallel while maintaining the security among the application programs.

Also, the enhancement of the rate of operation of the parallel computer created by multiple processor nodes is realized.

Also, the enhancement of failure resistance of a parallel computer by the disconnection of the processor nodes in a unit of each processor node is realized.

What is claimed is:

1. An information processing system, comprising:
a plurality of processor nodes for constituting parallel computers;
an information transmission line for connecting the processor nodes; and
a separation switch provided on the information transmission line for separating the information transmission line so that multiple processor nodes may create a plurality of parallel computers which are independent of one another.

2. The information processing system according to claim 1, wherein:
the separation switch physically separates the information transmission line.

3. The information processing system according to claim 1, wherein:
the information transmission line consists of an optical transmission line which creates a loop;
communications among multiple processor nodes are conducted by optical signals transmitted on the optical transmission line; and
the separation switch is an optical switch for separating the optical transmission line multiple loops and for uniting these loops.

4. The information processing system according to claim 1, wherein:
the information transmission line consists of a single optical transmission line;
communications among multiple processor nodes are conducted by wavelength division multiplexed optical signals transmitted on the optical transmission line; and
the separation switch is an optical switch for separating and connecting the optical transmission line which transmits the wavelength division multiplexed optical signals.

5. The information processing system according to claim 1, wherein:
the information transmission line consists of a plurality of optical transmission lines;
the optical transmission line for connecting the separation switch and the processor node that is the closest to the separation switch is selectively unified; and
wavelength division multiplexed optical signals are transmitted on the selectively unified optical transmission line.

6. The information processing system according to claim 1, wherein:
multiple processor nodes are connected via the information transmission line so that the two dimensional torus or the three dimensional torus is created; and
said processor nodes are separated, by the separation switch, to belong to the multiple two dimensional tori or the three dimensional tori which are different from the multiple processor nodes.

7. The information processing system according to claim 1, wherein:
each of the processor nodes is comprised of an input port and an output port;
the separation switch is comprised of a switch matrix for connecting multiple connection ports to which the input port and the output port are connected and the arbitrary connection port via the information transmission line;
the switch matrix connects the input ports and the output ports of the multiple processor nodes to create loops; and
the switch matrix skips and excludes a pair of the input port and the output port of each of the processor nodes from the loops so that the disconnection from the parallel computer is conducted in a unit of each of the processor nodes.

8. An information processing system, comprising:
first switches for binding multiple processor nodes constituting groups and controlling routes of information transmitted among the processor nodes in the groups;
a second switch for controlling routes of information transmitted among the processor nodes among the multiple groups that processor nodes are connected in a unit of the group via the multiple first switches; and
a third switch provided between the first switches and the second switch for controlling the presence and the absence of the connection with the second switch regarding each of the groups.

9. The information processing system according to claim 8, wherein:
the first switches and the second switch are connected via optical transmission lines which transmit wavelength division multiplexed optical signals; and
the third switch is an optical switch provided on the optical transmission lines.

10. The information processing system according to claim 8, wherein:
the third switch includes a function to connect the first switches disconnected from the second switch; and
the processor nodes respectively constitute a plurality of parallel computers which are independent of one another in a unit of the group as a minimal unit.

11. A method of controlling an information processing system to connect a plurality of processor nodes via an optical transmission line and cause the processor nodes to operate as parallel computers, comprising:
a step of arranging an optical switch on the optical transmission line; and
a step of causing the multiple processor nodes to operate as parallel computers that are independent of one another by separating the optical transmission line by the optical switch as occasion demands.

12. The method of controlling an information processing system according to claim 11, wherein:
information among the various processor nodes is transmitted and received by wavelength division multiplexed optical signals transmitted on the optical transmission line.

13. A method of controlling an information processing system in which a fat tree is created by binding multiple processor nodes constituting groups by first switches for controlling routes of information transmitted among the processor nodes in the groups and by binding multiple first switches by a second switch for controlling routes of information transmitted among the processor nodes among multiple groups, comprising:
a step of arranging a third switch on an information transmission line between the first switches and the second switch; and
a step of creating multiple parallel computers which are independent of one another in a unit of the group as a minimal unit by controlling the presence and the absence of the connection with the second switch regarding each of the groups by the third switch.

14. The method of controlling an information processing system according to claim 13, wherein:
the first switches and the second switch are connected via optical transmission lines which transmit wavelength division multiplexed optical signals; and
the presence and the absence of connection with the second switch regarding each of the groups is controlled by using an optical switch as the third switch based on the presence and the absence of separation of the optical transmission lines.
